(19) United States
(12) Patent Application Publication
(10) Pub. No.: US 2008/0125176 A1
(43) Pub. Date: May 29, 2008

(54) Mobile communication system, base band server, and signal transfer method used therein

(75) Inventor: Junichiroh Kojima, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/812,588

(22) Filed: Jun. 20, 2007

(30) Foreign Application Priority Data
Jun. 21, 2006 (JP) 2006-170819

(51) Int. Cl. H04M 1/00

(52) U.S. Cl. 455/561

(57) ABSTRACT

A weighting coefficient calculator reads “R1” to “R4” from incoming RSSI signals of serial signals, and sets weighting coefficients in multipliers. The multipliers multiply incoming received signals of the serial signals by the weighting coefficients. The weighting coefficient calculator calculates a total sum of the weighting coefficients that is the total of the weighting coefficients for an adding and dividing processor. The adding and dividing processor calculates a sum of the weighted incoming received signals and divide the sum of the signals by the total sum of the weighting coefficients.

This application is based upon and claims the benefit of priority from Japanese patent application No. 2006-170819, filed on Jun. 21, 2006, the disclosure of which is incorporated herein in its entirety by reference.

### BACKGROUND OF THE INVENTION

1. Field of the Invention

The present invention relates to a mobile communication system, a base band server and a signal transfer method used therein. Particularly the invention relates to a wireless base station device that includes a base station main device and an extended radio device in the mobile communication system adopting a CDMA (Code Division Multiple Access) method.

2. Description of the Related Art

In mobile communication systems that adopt the CDMA method, since a range at which a radio wave from a wireless base station device reaches is a communication area, a mobile station cannot be used in a blind zone such as a tunnel or an underground at which a radio wave from a wireless base station device does not reach. In recent years, in the mobile communication systems, the wireless base station device should process data to a lot of users according to the spread of mobile terminal devices such as cellular phones. For this reason, structures of the devices tend to be more complicated and larger. For this reason, the radio base station devices are divided into a base station main device that process base band signals of respective mobile terminal devices, and an extended radio device having antenna devices for amplifying an electric power or modulating/demodulating radio frequency signals.

Since extended radio devices are smaller than base station main devices, the extended radio devices can be installed in subway yards or underground malls, and thus they are effective for eliminating blind zones. Normally, since a communication area that is managed by a wireless base station device is divided into a plurality of service areas, an extended radio device is installed in each service area separated from the base station main device. The m-number (m: positive integer number) of extended radio devices having the same configuration are connected to one base station main device via optical transmission lines (for example, optical fibers) (for example, see Japanese Patent Application Laid-Open Nos. 2006-013778, 2005-117352, 2005-323076, 10-200484 and 11-284639).

The mobile communication system adopting the CDMA method is described with reference to FIGS. 1 to 3. In FIG. 1, a wireless base station device 5 is connected to a base band server 6 via a transmission line 500, and the base band server 6 is connected to optical extended transmission/reception devices 7-1 to 7-n via optical fibers 601 to 60n (n: positive integer number). The base band server 6 has an adding and subtracting processor 61. The optical extended transmission/reception devices 7-1 to 7-n are provided in subareas #1 to #n of service areas #1 to 3m (m: positive integer number) and has antennas 71-1 to 71-n, respectively.

In FIG. 2, the wireless base station device 5 has a base band processor 51 and SerDes (Serializer/Deserializer) sections 52-1 to 52-m. The base band server 6 has distribution synthesizing sections 61-1 to 61-m and O/E (Optical/Electronic) converters 63-1 to 63-m.

The optical extended transmission/reception device 7-1 has the antenna 71-1, an O/E converter 72-1, a SerDes section 73-1, a delay compensating section 74-1 and a radio section 75-1. The other optical extended transmission/reception devices 7-2 to 7-n have the same configuration as that of the optical extended transmission/reception device 7-1.

Incoming received signals from the mobile stations 4 received by the optical extended transmission/reception devices 7-1 to 7-n are demodulated by a radio section 75-1 shown in FIG. 2, and are A/D (analog-digital) converted. The signals are converted into serial signals by the SerDes section 73-1, and are converted into light signals by the O/E converter 72-1 so as to be sent to the base band server 6.

In the base band server 6, the O/E converters 63-1 to 63-m convert the light signals from the optical extended transmission/reception devices 7-1 to 7-n into electrical signals, respectively. The distribution synthesizing sections 62-1 to 62-m calculate a total of the incoming received signals of the n-number of the optical extended transmission/reception devices 7-1 to 7-n, and divides the total by n so as to average the signal. A base band processor 51 of the wireless base station device 5 executes the despreading process so as to separate and extract the incoming received signals from the respective mobile stations 4. The process of the averaging process is shown in FIG. 3.

The function for processing incoming signals from the distribution synthesizing sections 62-1 to 62-m is realized by the averaging processor 64 in FIG. 3. In this case, when four optical extended transmission/reception devices 7-1 to 7-4 are connected, a total of seven signals including an incoming received signals 713 from the mobile station 4 to an incoming signal 719 from the mobile station is calculated using demodulated signals 701 to 704. The total is divided by “4” which is the number of the connected optical extended transmission/reception devices 7-1 to 7-4, and one synthesized serial signal 712 is generated.

In conventional systems, since an incoming RSSI (Received Signal Strength Indicator) signal is not added, a serial signal E2 includes only a serial signal generated from an incoming demodulated signal 711 after synthesis. With this operation, the incoming demodulated signal 711 after synthesis is generated according to the following generation formula:

(S1+S2+S3+S4)/4.

In the conventional averaging process, however, each of the optical extended transmission/reception device divides the total of signals by the number n of the optical extended transmission/reception devices regardless of the number of calls during the communication of the optical extended transmission/reception devices. For this reason, an incoming received signal of the optical extended transmission/reception device whose number of calls is large in the synthesized incoming received signals after the averaging process becomes low.

In the conventional averaging process, since optical extended transmission/reception devices that are not called are subjects to the averaging process, the synthesized incoming received signal after the averaging process cannot fully use a predetermined bit width. As a result, the signal becomes lower than a synthetic loss.

In any cases, in the conventional averaging process, NF (Noise Figure) is deteriorated, and an influence of noises on the process of despreading becomes great, thereby reducing the number of subscribers to be accommodated in the system.

In FIG. 1, the base band server 6 adds up the incoming received signals from “n” optical fibers 401 to 40n, and divide the added-up signal by “n” which is the number of the optical fibers 401 to 40n to make an average. As a result, one incoming received signal is synthesized. Any problem does not arise if traffic is distributed uniformly in the n-number of subareas #1 to #n, but when the traffic is concentrated on n1 subareas and a non-communication state occurs in the residual n0 areas, NF is deteriorated.

When n0 subareas which are in the non-communication state and do not require the addition averaging are included in the calculation, the incoming received signals in the communication areas are divided by (n1+n0). Since the necessary signal can be obtained by division by n1, NF of n1/(n1+n0) is deteriorated.

### SUMMARY OF THE INVENTION

An exemplary object of the invention is to provide a mobile communication system, a base band server and a signal transfer method that solve the above problems and can minimize NF deterioration due to synthesis.

A mobile communication system according to an exemplary aspect of the invention includes a wireless base station device and at least one optical extended transmission/reception devices that are connected by optical fibers and a base band server, wherein the base band server includes: a calculator that calculates weighting coefficients based on information from optical extended transmission/reception devices representing received electric field strength of the optical extended transmission/reception devices; a multiplier that multiplies incoming received signals from the optical extended transmission/reception devices by the weighting coefficients; and an adder that sums up the multiplied results and divides the summed-up result by a total sum of the weighting coefficients.

A base band server according to an exemplary aspect of the invention is connected to a wireless base station device via a transmission path and is connected to at least one optical extended transmission/reception devices connected to the wireless base station device via optical fibers. The base band server includes: a calculator that calculates weighting coefficients based on information from optical extended transmission/reception devices representing received electric field strength of the optical extended transmission/reception devices; a multiplier that multiplies incoming received signals from the optical extended transmission/reception devices by the weighting coefficients; and an adder that sums up the multiplied results and divides the summed-up result by a total sum of the weighting coefficients.

A signal transfer method according to an exemplary aspect of the invention is used in a mobile communication system in which a wireless base station device and at least one optical extended transmission/reception device are connected via optical fibers and a base band server, wherein the base band server executes the method comprising: calculating weighting coefficients based on information from optical extended transmission/reception devices representing received electric field strength of the optical extended transmission/reception devices; multiplying incoming received signals from the optical extended transmission/reception devices by the weighting coefficients; and summing up the multiplied results and dividing the summed-up result by a total sum of the weighting coefficients.

### BRIEF DESCRIPTION OF THE DRAWINGS

Features of the disclosed embodiments will be described by way of the following detailed description with reference to the accompanying drawings in which:

FIG. 1 is a block diagram illustrating a configuration of a conventional mobile communication system;

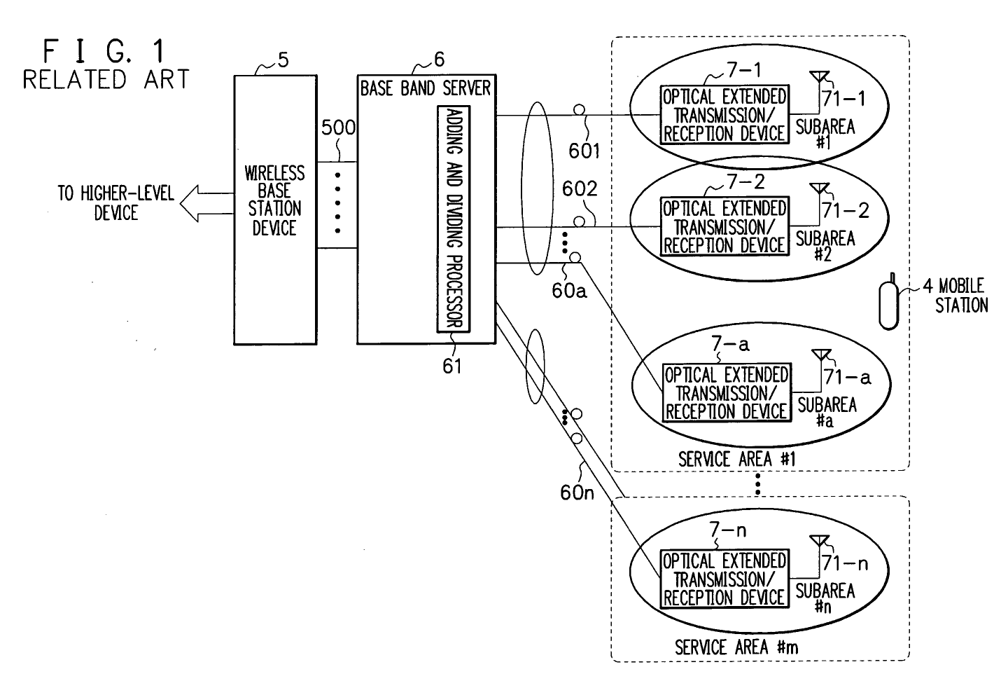

FIG. 2 is a diagram illustrating a generating process of incoming received signals in a conventional system;

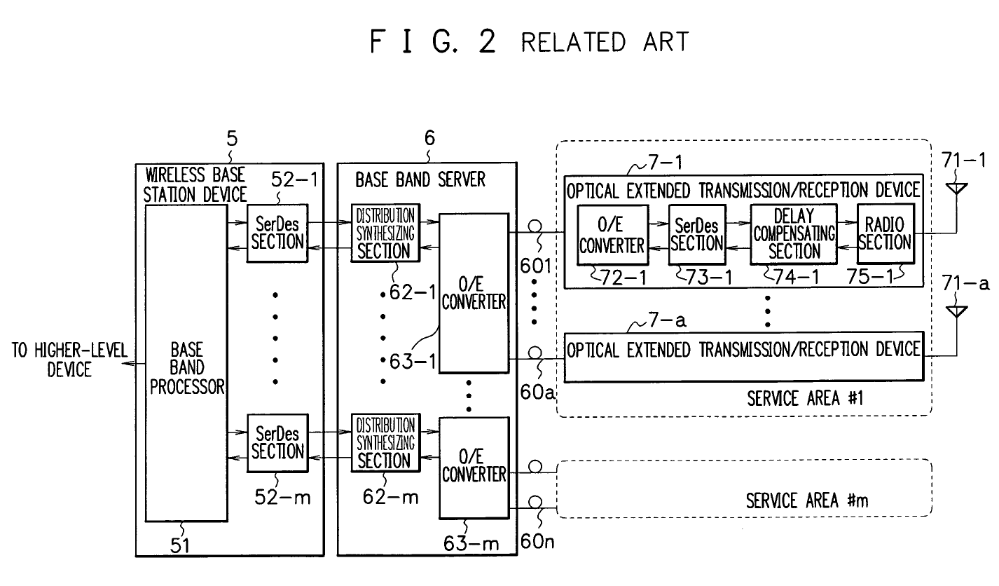

FIG. 3 is a diagram illustrating a weighted adding-up process in the conventional system;

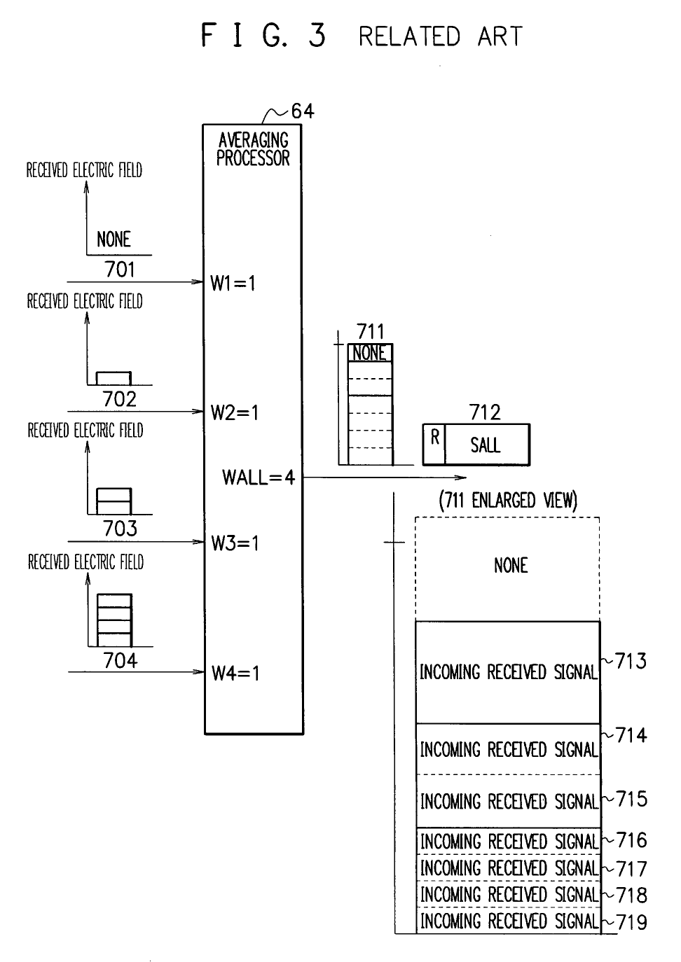

FIG. 4 is a block diagram illustrating a configuration of a mobile communication system;

FIG. 5 is a diagram illustrating a generating process of incoming received signals; and

FIG. 6 is a diagram illustrating an averaging process of serial signals.

### DESCRIPTION OF EXEMPLARY EMBODIMENTS

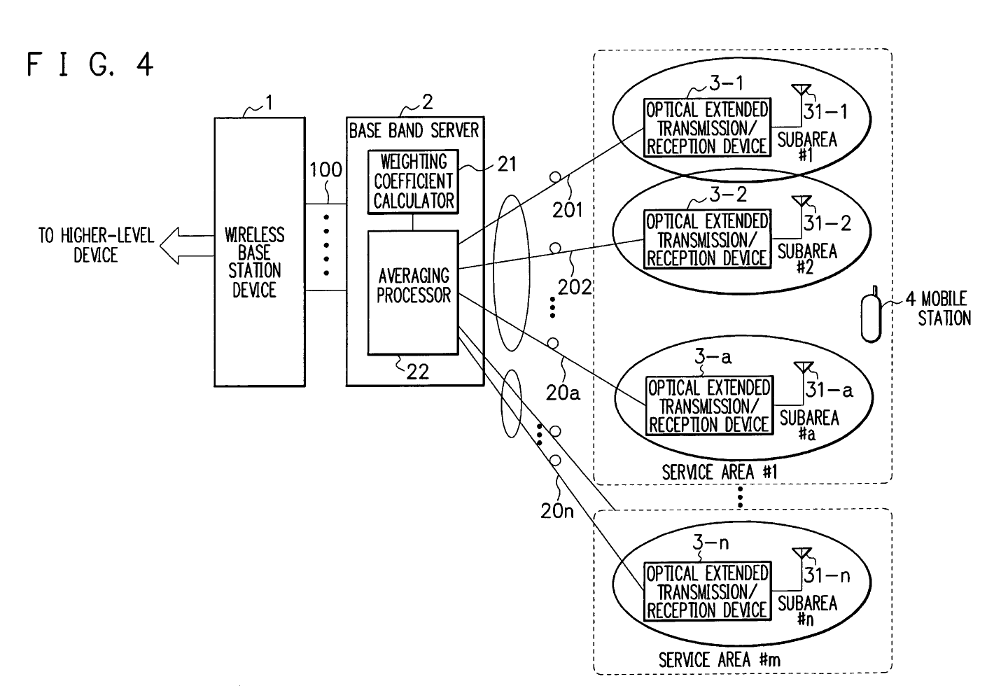

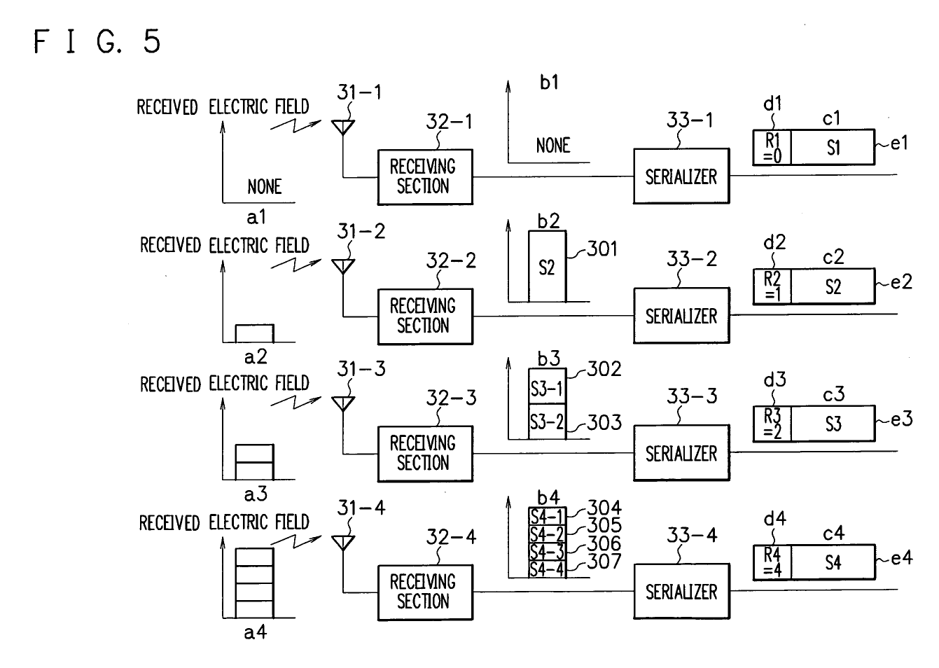

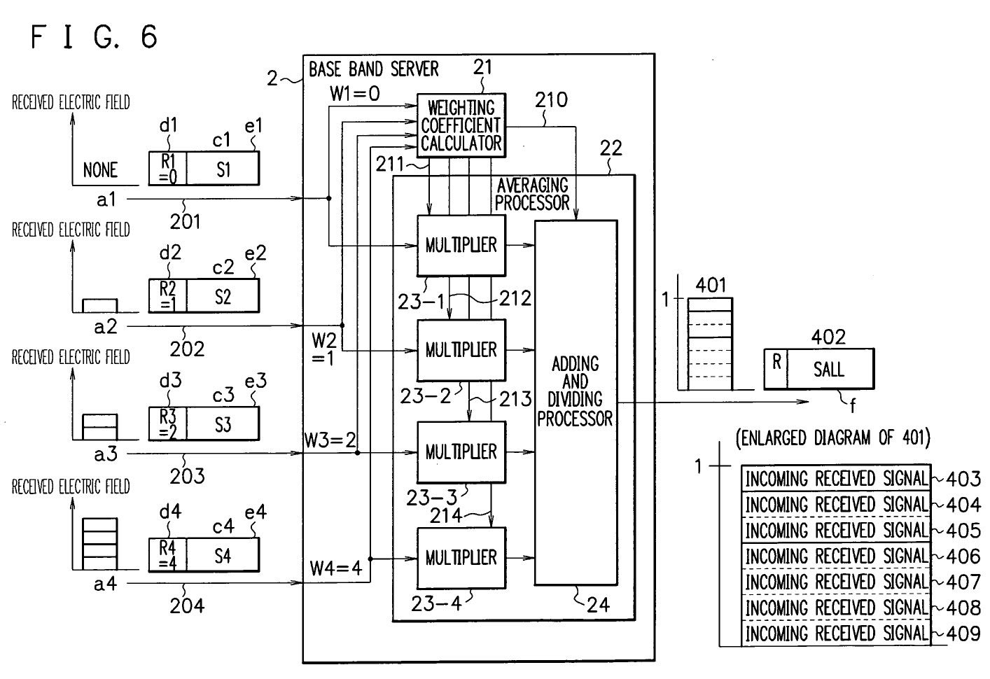

Exemplary embodiments are described below with reference to the drawings. FIG. 4 is a block diagram illustrating a configuration of a mobile communication system. FIG. 5 is a diagram illustrating a generating process of incoming received signals. FIG. 6 is a diagram illustrating an averaging process of serial signals.

FIG. 4 illustrates a mobile phone base station system as one example of the mobile communication system. The mobile communication system includes a wireless base station device 1, a base band server 2, and optical extended transmission/reception devices 3-1 to 3-n (n: positive integer number).

The base server 2 has a weighting coefficient calculator 21 and an averaging processor 22, and is connected with optical extended transmission/reception devices 3-1 to 3-n via optical fibers 201 to 20n. The optical extended transmission/reception devices 3-1 to 3-n are installed in subareas #1 to #n of service areas #1 to #m, and have antennas 31-1 to 31-n, respectively.

FIG. 5 illustrates a generating process of incoming received signals in the optical extended transmission/reception devices 3-1 to 3-4. The optical extended transmission/reception devices 3-1 to 3-4 have receiving sections 32-1 to 32-4 and serializers 33-1 to 33-4, respectively. Optical extended transmission/reception devices (not shown) whose n is 5 or more can be adapted similarly to this case.

FIG. 6 illustrates an averaging process of serial signals in the base band server 2. The base band server 2 includes the weighting coefficient calculator 21 and the averaging processor 22. The averaging processor 22 has multipliers 23-1 to 23-4 and an adding and dividing processor 24.

The optical extended transmission/reception device 3-1 receives an incoming received radio wave from the mobile stations 4 in a communication state in the subarea #1 and digitizes them so as to send them as incoming received signals C1-2 (=S1) shown in FIG. 5 to the base band server 2 via the optical fiber 201. Received electric field strength of the optical extended transmission/reception device 3-1 is also digitalized, and is superposed on the optical fiber 201 so as to be sent as an incoming RSSI signal C1-1 (=R1) shown in FIG. 5.

FIG. 5 illustrates a generating process of an incoming received signal e1 (S=1) and an incoming RSSI signal d1 (=R1). FIG. 6 illustrates a weighted adding-up process of a serial signal shown in FIG. 5. The other optical extended transmission/reception devices 3-2 to 3-n operate similarly to the optical extended transmission/reception device 3-1.

With reference to FIGS. 4 to 6, the operation of the mobile communication system (=mobile phone base station system) is described below. The following description refers to the case where the four optical extended transmission/reception devices 3-1 to 3-4 are connected to the base band server 2.

The optical extended transmission/reception device 3-1 receives incoming received electric waves from the mobile stations 4 in a communication state in the subarea #1 by means of the antenna 31-1 and the receiving section 32-1, and digitalizes them so as to send them as incoming received signals e1 (=S1) via the optical fiber 201 to the base band server 2. Received electric field strength of the optical extended transmission/reception device 3-1 is also digitalized, and is superposed as incoming RSSI signals d1 (=R1) on the optical fiber 201 so as to be sent out.

As to a characteristic of the CDMA (Code Division Multiple Access) method, an APC (Automatic Power Control) function is carried out so that the incoming received signals from the mobile stations 4 become the same received electric powers. For this reason, the RSSI signals d1 have a value that is proportional to the number of calls in the subarea #1.

The weighting coefficient calculator 21 of the base band server 2 calculates weighting coefficients 211 (=W1) from the incoming RSSI signals d1 (=R1) sent from the optical extended transmission/reception device 3-1. The averaging processor 22 multiples the incoming received signals e1 (=S1) sent via the optical fiber 201 by the weighting coefficients 211 (=W1) generated by the weighting coefficient calculator 21 using the multiplier 23-1, and calculates a total sum of the received signals using the adding and dividing processor 24 according to the following formula:

Summation of the received signals=S1·W1+ . . . +Sa·Wa+ . . . +Sn·Wn.

Simultaneously, the weighting coefficient calculator 21 calculates a total sum 210 of the weighting coefficients according to the following formula:

Summation of the weighting coefficients=W1+ . . . +Wn

The total sum of the received signals is divided by the total sum of the weighting coefficients, and a synthesized incoming received signal 402 (=Sₐ₁₁) is generated and sent to the wireless base station device 1. When viewed from the wireless base station device 1, the incoming received signal 402 appears to have a signal form that is the same as that of the incoming received signal sent from one optical extended transmission/reception device. For this reason, a dispersed receiving method can be achieved.

The generating process of the incoming received signals e1 to e4 is described with reference to FIG. 5. FIG. 5 illustrates an example where the four optical extended transmission/reception devices are installed.

The optical extended transmission/reception device 3-1 does not have a mobile station in a communication state and thus does not have an incoming received electric wave. Therefore, a received electric field a1 is not present. The optical extended transmission/reception device 3-2 has one mobile station in a communication state, and receives an electric wave in a received electric field a2. The optical extended transmission/reception device 3-3 has two mobile stations in a communication state, and receives electric waves for two stations in a received electric field a3. The optical extended transmission/reception device 3-4 has four mobile stations in a communication state, and receives electric waves for four stations in a received electric field a4.

The optical extended transmission/reception device 3-4 demodulates the sum of the signals from the four mobile stations and A/D-converts the sum by 8 bits. Therefore, an output from the receiving section 32-4 in the optical extended transmission/reception device 3-4 is a demodulated signal b4 obtained by building up four received signals including the incoming received signals 304 (=S4-1) from the mobile stations to incoming received signals 307 (=S4-4) from the mobiles stations on 8-bit width.

The extended optical transmission/reception device 3-4 converts the demodulated signal b4 into a serial signal c4 using the serializer 33-4 so as to send it as an incoming received signal c4 (=S4) of 8-bit width to the base band server 2. An incoming RSSI signal d4 (=R4) from the optical extended transmission/reception device 3-4 is added to the serial signal c4. Since signals for four stations are received, a value “R4=4” is set.

Similarly, the optical extended transmission/reception device 3-2 generates an incoming received signal e2 (=S2) of 8-bit width from an incoming received signal from one mobile station. Since the optical extended transmission/reception device 3-2 has one mobile station in a communication state, the value of an incoming RSSI signal d2 (=R2) is set to 1 (“R2=1”). The optical extended transmission/reception device 3-2 synthesizes the incoming received signal e2 and the incoming RSSI signal d2 so as to generate a serial signal c2 and send the signal c2 to the base band server 2.

Similarly the optical extended transmission/reception device 3-3 generates an incoming received signal c3 of 8-bit width from incoming received signals from two mobiles stations. Since the optical extended transmission/reception device 3-3 has the two mobile stations in a communication state, the value of an incoming RSSI signal d3 (=R3) is set to 2 (“R3=2”). The optical extended transmission/reception device 3-3 synthesizes an incoming received signal e3 and the incoming RSSI signal d3 so as to generate a serial signal c3 and sends the signal c3 to the base band server 2.

When these operations are repeated at a high speed, demodulated signals of the optical extended transmission/reception devices 3-1 to 3-4 are restored, and an incoming received signal of each mobile station is extracted through the despreading process. In the above example, the incoming received signals e1 to e4 have the 8-bit width for simplification of the description, but any value can be set for the widths according to accuracy to be obtained.

FIG. 6 illustrates a detailed configuration of weighted adding-up of the serial signal shown in FIG. 5. A signal process of the optical extended transmission/reception device 3 is described. In FIG. 6, the serial signal c4 of FIG. 5 flows in the optical fiber 204, but the combination of the serial signal c4 and the original modulated signal b4 is described for simplification of the description. The averaging processor 22 includes the multipliers 23-1 to 23-4 and the adding and dividing processor 24.

The weighting coefficient calculator 21 reads “R4” from the incoming RSSI signal d4 of the serial signal c4, and sets a weighting coefficient “W4=R4=4” to the multiplier 23-4. The multiplier 23-4 multiplies the incoming received signal e4 (=S4) of the serial signal c4 by the weighting coefficient “W4”. The multiplied result is obtained by multiplying the 8-bit signal by 4, namely, the signal has a 10-bit width. The signal of 10-bit width is sent as the weighted incoming received signal to the adding and dividing processor 32.

The weighting coefficient calculator 21 generates values “W1=0”, “W2=1” and “W3=2” from the incoming RSSI signals d1 to d3 according to the similar method, and sets these values to the corresponding multipliers 23-1 to 23-3. The multipliers 23-1 to 23-3 multiply the incoming received signals e1, e2 and e3 by the weighting coefficients 211 to 213, respectively, so as to generate weighted incoming received signals and send them to the adding and dividing processor 32.

The weighting coefficient calculator 21 calculates a total sum of weighting coefficients 210 (=Wall) as the total of the weighting coefficients “W1” to “W4” for the adding and dividing processor 24, and sets a value “Wall=7”. The adding and dividing processor 32 calculates a sum of the weighted incoming received signals and divide the sum by the value “Wall=7”. The divided result is a synthesized serial signal 402.

With the above operation, a synthesized incoming received signal f included in the synthesized serial signal 402 is generated according to the following formula:

f=(S1·W1+S2·W2+S3·W3+S4·W4)/(W1+W2+W3+W4)

=(S2+2×S3+4×S4)/7

This is equivalent to that a demodulated signal 401 after synthesis is received. That is to say, the synthesized incoming received signal f is a 8-bit serial signal which is generated in the following manner. Seven incoming received signals 301 to 307 from the mobiles stations are converted into incoming received signals 403 to 409 from the mobile stations, and are summed up so that the demodulated signal 401 after synthesis is generated. The demodulated signal 401 is stored in the same bid width as that of the serials signals c1 to c4.

The coefficient of the incoming received signal “S1” without communication becomes 0 (W1=0), and this is not subject to the addition and division. When the synthesized serial signal 402 is read on the side of the wireless base station device 1, this seems to be the same as the incoming signal from one optical extended transmission/reception device. The one optical extended transmission/reception device seems to receive incoming received signals from seven mobile stations in communication state in four subareas, so that dispersion reception can be realized.

In order to simplify the description, the incoming RSSI signal d (=Ra) and the weighting coefficient (=Wa) establish the relationship: Wa=Ra, but the following generation formula can be set:

Wa=A×Ra+B (A and B are any numbers).

An outgoing signal from the wireless base station device 1 is copied and the copied signals are distributed to the optical extended transmission/reception devices 3-1 to 3-n as described in the conventional method (see Patent Document 1) so that dispersion transmission can be realized.

In this embodiment, when the incoming received signals are synthesized by the base band server 2, the incoming received signals are multiplied by the weighting coefficient so as to be summed up. Thereafter, the summed-up signal is divided by the total sum of the weighting coefficients so as to be synthesized, thereby minimizing an NF (Noise Figure) deterioration due to synthesis.

The effect of the present invention is exerted mainly on indoor service systems of mobile phones. The number of mobile stations which are present in indoor service areas is smaller than that in outdoor service areas. Electric waves do not reach the mobile stations due to walls and a lot of small rooms, and this requires a lot of small areas. Therefore, a lot of small areas cover light traffic, and thus the dispersion transmission/reception method with which one wireless base station device covers a plurality of areas is effective from a viewpoint of profitability.

An outdoor system in a sparsely populated region has a larger radius of area, but when many large areas cover sparse traffic as the above case, the cost of equipment can be reduced, thereby improving profitability.

### Second Exemplary Embodiment

A mobile communication system is a mobile phone base station system in which the wireless base station device and at least one optical extended transmission/reception devices are connected by optical fibers and a base band server. This system is provided with a calculator that calculates weighting coefficients from incoming RSSI (Received Signal Strength Indicator) signals of the optical extended transmission/reception devices, and a multiplier that multiplies incoming received signals by the weighting coefficients and adds them up when the base band server synthesizes the incoming received signals so as to divide the added-up result by a total sum of the weighting coefficients. As a result, NF (Noise Figure) deterioration due to the synthesis of the incoming received signals can be minimized.

More concretely, in the mobile communication system, the base band server performs addition and takes an average of incoming signals flowing on n optical fibers (n: positive integer). The base band server synthesizes the signals into one incoming received signal so as to send a signal to the wireless base station device via the transmission path. At this time, an averaging processor multiplies the incoming RSSI signals from the optical extended transmission/reception devices by the weighting coefficients generated by the weighting coefficient calculator. Thereafter, the signals are added up and are divided by the total sum of the weighting coefficients. An outgoing signal flowing on the transmission path is copied by the base band server, and the copied same signals are distributed to the n optical fibers.

In the mobile communication system, n optical extended transmission/reception devices can be connected to one wireless base station device, and only incoming received signals used for communication are weighted and averaged according to the number of calls. For this reason, the NF deterioration due to the synthesis of the incoming received signals can be minimized.

In a CDMA (Code Division Multiple Access) method, since noises act as interference, the number of subscribers to be accommodated in the conventional mobile communication system is less than a system of the present invention.

In the mobile communication system of the present invention, an incoming RSSI signals of the optical extended transmission/reception device connected to any optical fiber is superposed so as to be sent to the base band server. The incoming received signals (=Sa) are multiplied by the weighting coefficients Wa generated by the weighting coefficient calculator based on the incoming RSSI signals (=Ra). The total sum of the signals is divided by the total sum of the weighting coefficient, so that the incoming received signal is synthesized.

The synthesized incoming received signal (=Sₐ₁₁) to be sent from the base band server to the wireless base station device is generated according to the following formula:

Sₐ₁₁=(S1·W1+ . . . +Sa·Wa+ . . . +Sn·Wn)/(W1+ . . . +Wa+ . . . +Wn).

Therefore, even when bias of traffic occurs in each subarea, the system can effectively work. In conventional methods which adopts simple average, incoming received signals are generated according to the following formula:

Sₐ₁₁=(S1+ . . . Sn)/n.

For this reason, this case is equivalent to that all weighting coefficients W1, . . . , Wa, . . . , Wn of the present invention are set to “1”.

An exemplary advantage according to the invention is that the NF deterioration due to synthesis can be minimized by the above configuration and the operations.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A mobile communication system in which a wireless base station device and at least one optical extended transmission/reception device are connected by optical fibers and a base band server, wherein the base band server includes:
a calculator that calculates weighting coefficients based on information from optical extended transmission/reception devices representing received electric field strength of the optical extended transmission/reception devices;
a multiplier that multiplies incoming received signals from the optical extended transmission/reception devices by the weighting coefficients; and
an adder that sums up the multiplied results and divides the summed-up result by a total sum of the weighting coefficients.

2. The mobile communication system according to claim 1, wherein the information from the optical extended transmission/reception devices is posted as incoming RSSI (Received Signal Strength Indicator) signals obtained by digitalizing the received electric field strength.

3. The mobile communication system according to claim 1, wherein the base band server copies an outgoing signal flowing through a transmission path between the wireless base station device and the base band server so as to distribute the same signals to the optical fibers between the base band server and the optical extended transmission/reception devices.

4. A base band server that is connected to a wireless base station device via a transmission path and is connected to at least one optical extended transmission/reception devices connected to the wireless base station device via optical fibers, the base band server comprising:
a calculator that calculates weighting coefficients based on information from optical extended transmission/reception devices representing received electric field strength of the optical extended transmission/reception devices;
a multiplier that multiplies incoming received signals from the optical extended transmission/reception devices by the weighting coefficients; and
an adder that sums up the multiplied results and divides the summed-up result by a total sum of the weighting coefficients.

5. The base band server according to claim 4, wherein the information from the optical extended transmission/reception devices is posted as incoming RSSI (Received Signal Strength Indicator) signals obtained by digitalizing the received electric field strength.

6. The base band server according to claim 1, wherein an outgoing signal flowing through a transmission path between the wireless base station device and the base band server is copied, and the copied same signals are distributed to the optical fibers between the base band server and the optical extended transmission/reception devices.

7. A signal transfer method that is used in a mobile communication system in which a wireless base station device and at least one optical extended transmission/reception devices are connected via optical fibers and a base band server, wherein the base band server performs the method comprising:
calculating weighting coefficients based on information from the optical extended transmission/reception devices representing received electric field strength of the optical extended transmission/reception devices;
multiplying incoming received signals from the optical extended transmission/reception devices by the weighting coefficients; and
summing up the multiplied results and dividing the summed-up result by a total sum of the weighting coefficients.

8. The signal transfer method according to claim 7, wherein the information from the optical extended transmission/reception devices is posted as incoming RSSI (Received Signal Strength Indicator) signals obtained by digitalizing the received electric field strength.

9. The signal transfer method according to claim 7, wherein the base band server copies an outgoing signal flowing through a transmission path between the wireless base station device and the base band server so as to distribute the copied same signals to the optical fibers between the base band server and the optical extended transmission/reception devices.

10. A mobile communication system in which a wireless base station device and at least one optical extended transmission/reception device are connected by optical fibers and a base band server, wherein the base band server includes:
means for calculating weighting coefficients based on information from optical extended transmission/reception devices representing received electric field strength of the optical extended transmission/reception devices;
means for multiplying incoming received signals from the optical extended transmission/reception devices by the weighting coefficients; and
means for summing up the multiplied results and dividing the summed-up result by a total sum of the weighting coefficients.

11. A base band server that is connected to a wireless base station device via a transmission path and is connected to at least one optical extended transmission/reception devices connected to the wireless base station device via optical fibers, the base band server comprising:
means for calculating weighting coefficients based on information from optical extended transmission/reception devices representing received electric field strength of the optical extended transmission/reception devices;
means for multiplying incoming received signals from the optical extended transmission/reception devices by the weighting coefficients; and
means for summing up the multiplied results and divide the summed-up result by a total sum of the weighting coefficients.
